(19) United States
(12) Patent Application Publication
(10) Pub. No.: US 2025/0328125 A1
(43) Pub. Date: Oct. 23, 2025

(54) PLANT OPERATION ASSISTANCE SYSTEM

(71) Applicant: Mitsubishi Electric Corporation, Chiyoda-ku, Tokyo (JP)

(72) Inventors: Kenta FUKAMI, Chiyoda-ku, Tokyo (JP); Nami YAMAMOTO, Chiyoda-ku, Tokyo (JP); Mitsunobu YOSHINAGA, Chiyoda-ku, Tokyo (JP)

(73) Assignee: Mitsubishi Electric Corporation, Chiyoda-ku, Tokyo (JP)

(21) Appl. No.: 18/864,335

(22) PCT Filed: May 20, 2022
(86) PCT No.: PCT/JP2022/020962

§ 371 Date: Nov. 8, 2024

(51) Int. Cl. G05B 19/418

(52) U.S. Cl. CPC G05B 19/41835; G05B 2219/37591

(57) ABSTRACT

A plant operation assistance system includes: a risk calculation unit which calculates a risk of failure in a measure against an event against which the measure should be taken; an operation influencing factor determination unit which determines an operation influencing factor on the basis of a performance situation and an environment situation respectively determined on the basis of information indicating an internal characteristic of an operator and information indicating an external characteristic of the operator; and a step importance degree determination unit which determines, on the basis of the operation influencing factor and each of step importance indexes calculated from the risk, a step importance degree of a corresponding one of steps in a case of performing the step by the operator.

### TECHNICAL FIELD

The present disclosure relates to a plant operation assistance system.

### BACKGROUND ART

In recent years, software-type digital monitoring control panels instead of conventional hardware-type analog monitoring control panels have been increasingly introduced for operation assistance systems for large-scale plants in the field of electric power and the like. In each of the digital monitoring control panels, interfaces of respective functions are integrated to a graphical interface, and an operator performs a step through the graphical interface, whereby the device is downsized and manipulation load on the operator is mitigated. Also, in plant operation, steps to be performed against an event and details of the steps are predetermined, and the operator operates the plant according to the steps and the details of the steps which have been predetermined. Meanwhile, influences of the steps on the plant differ among the steps. Thus, in a case such as a case where a plurality of units are simultaneously operated or a case where a plurality of events have simultaneously occurred, determination as to which step is to be preferentially performed needs to be made, and the result of the determination needs to be presented to the operator. Here, each of the “events” refers to an event indicating occurrence of an abnormality in the plant or appearance of a sign of the abnormality, and is an event against which a measure should be taken.

A conceivable method for determining degrees of priority of steps and presenting the result of the determination to an operator is, for example, a method described in Patent Document 1. The method is for assistance in running (operation assistance) of a plant and includes: determining degrees of priority of measures regarding task instructions (steps) on the basis of degrees of influence on surrounding environments including the operation state of the plant; and reporting the task instructions in an order of degrees of priority of tasks that is determined on the basis of the degrees of priority of measures.

### CITATION LIST

### Patent Document

Patent Document 1: Japanese Laid-Open Patent Publication No. 2021-144705

### SUMMARY OF THE INVENTION

### Problem to Be Solved by the Invention

However, although the technique described in Patent Document 1 includes determining the degrees of priority of measures and the degrees of priority of tasks on the basis of situations of the plant such as the degrees of influence on the surrounding environments including the operation state of the plant, the technique has a problem that, for example, changes in the situation of the operator over time such as change in the performance of the operator are not considered.

The present disclosure has been made to solve the above problem, and an object of the present disclosure is to provide a plant operation assistance system in which change in the situation of an operator is reflected in determination of degrees of importance of respective steps so that more appropriate operation assistance can be performed.

### Means to Solve the Problem

A plant operation assistance system according to the present disclosure is a plant operation assistance system for assisting an operator in operating a plant, the plant operation assistance system including: a plant information acquisition unit which acquires plant information about the plant; a plant situation determination unit which determines, on the basis of the plant information, a plant situation including information indicating whether or not an event against which a measure should be taken has occurred; an operation information acquisition unit which acquires operation information about the plant; an operation situation determination unit which determines, on the basis of the operation information, an operation situation including information indicating which step among one or more steps included in the measure against the event is being currently performed; a performance information acquisition unit which acquires performance information indicating an internal characteristic of the operator; a performance situation determination unit which determines a performance situation on the basis of the performance information; an environment information acquisition unit which acquires environment information indicating an external characteristic of the operator; an environment situation determination unit which determines an environment situation on the basis of the environment information; a risk calculation unit which calculates a risk of failure in the measure against the event on the basis of the plant situation, the operation situation, and predetermined risk information; a step importance index calculation unit which calculates a step importance index as an index for importance of each of the steps on the basis of the risk; an operation influencing factor determination unit which determines an operation influencing factor of the operator on the basis of the performance situation, the environment situation, and a predetermined operation influencing factor rule; a step importance degree determination unit which determines, on the basis of the step importance index, the operation influencing factor, and a predetermined step importance degree rule, a step importance degree of the step in a case of performing the step by the operator; and a step information presentation unit which presents, to the operator, step information in which the step importance degree has been reflected.

### Effect of the Invention

In the plant operation assistance system according to the present disclosure, change in the situation of an operator is reflected in determination of degrees of importance of respective steps so that more appropriate operation assistance can be performed.

### BRIEF DESCRIPTION OF THE DRAWINGS

FIG. 1 is a function block diagram showing a plant operation assistance system according to embodiment 1.

FIG. 2 shows an example of a hardware configuration for realizing functional units of the plant operation assistance system according to embodiment 1.

FIG. 3 is a flowchart showing actions of the plant operation assistance system according to embodiment 1.

FIG. 4 shows an example of an indication of steps according to embodiment 1.

FIG. 5 shows an example of performance situation determination according to embodiment 1.

FIG. 6 shows an example of environment situation determination according to embodiment 1.

FIG. 7 shows an example of an operation influencing factor rule according to embodiment 1.

FIG. 8 shows an example of risk information according to embodiment 1.

FIG. 9 shows an example of risk calculation according to embodiment 1.

FIG. 10 shows an example of risk calculation according to embodiment 1.

FIG. 11 shows an example of risk calculation according to embodiment 1.

FIG. 12 shows an example of a step importance degree rule according to embodiment 1.

FIG. 13 shows an example of presentation by a step information presentation unit according to embodiment 1.

FIG. 14 shows an example of risk calculation according to embodiment 1.

FIG. 15 shows an example of performance situation determination according to embodiment 1.

FIG. 16 shows an example of presentation by the step information presentation unit according to embodiment 1.

FIG. 17 is a function block diagram showing a plant operation assistance system according to embodiment 2.

FIG. 18 shows an example of the relationship between operation influencing factors and operation results according to embodiment 2.

FIG. 19 shows an example of a corrected operation influencing factor rule according to embodiment 2.

FIG. 20 shows an example of presentation by the step information presentation unit according to embodiment 2.

### DESCRIPTION OF EMBODIMENTS

### Embodiment 1

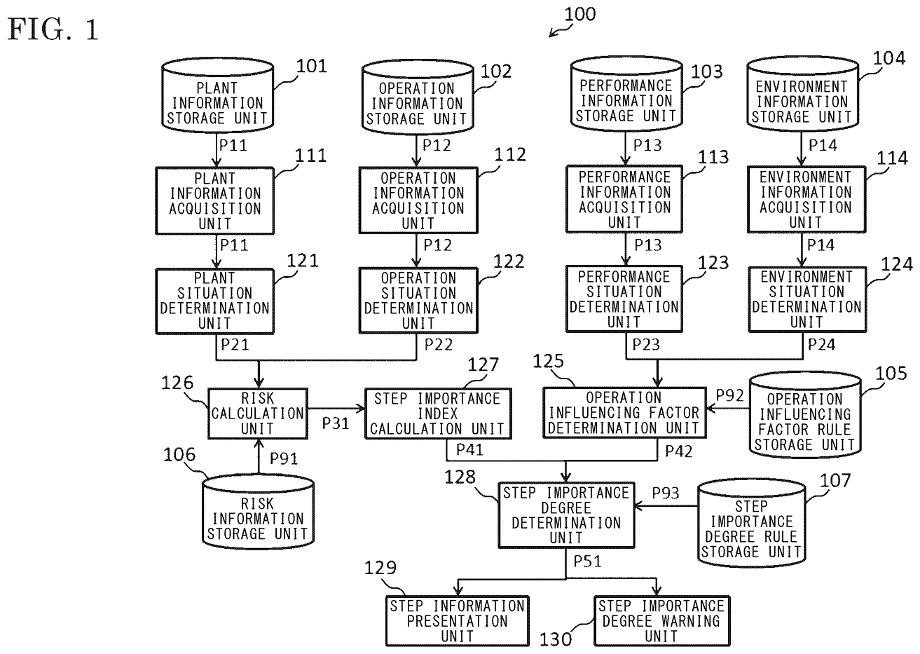

Embodiment 1 will be described with reference to FIG. 1 to FIG. 16. FIG. 1 is a function block diagram showing a plant operation assistance system according to embodiment 1. The plant operation assistance system 100 is for assisting an operator in operating a plant (not shown) being monitored and is for determining a step importance degree P51 of each of steps on the basis of: a plant situation P21 of the plant being monitored; an operation situation P22 of the plant being monitored; a performance situation P23 indicating an internal situation of the operator; and an environment situation P24 of the environment in which the operator is present. The number of the plants being monitored may be one or may be two or more. The plant being monitored is, for example, a power plant or the like, and the type of the plant is not limited.

The plant operation assistance system 100 includes: a plant information storage unit 101 which stores therein plant information P11; a plant information acquisition unit 111; and a plant situation determination unit 121. The plant operation assistance system 100 includes: an operation information storage unit 102 which stores therein operation information P12; an operation information acquisition unit 112; and an operation situation determination unit 122. The plant operation assistance system 100 includes: a performance information storage unit 103 which stores therein performance information P13; a performance information acquisition unit 113; and a performance situation determination unit 123. The plant operation assistance system 100 includes: an environment information storage unit 104 which stores therein environment information P14; an environment information acquisition unit 114; and an environment situation determination unit 124.

In addition, the plant operation assistance system 100 includes: a risk calculation unit 126 which calculates a risk P31; a risk information storage unit 106 which stores therein pieces of risk information P91; a step importance index calculation unit 127 which calculates a step importance index P41; an operation influencing factor determination unit 125 which determines an operation influencing factor P42; an operation influencing factor rule storage unit 105 which stores therein an operation influencing factor rule P92; a step importance degree determination unit 128 which determines a step importance degree P51; and a step importance degree rule storage unit 107 which stores therein a step importance degree rule P93.

In addition, the plant operation assistance system 100 includes a step information presentation unit 129 and a step importance degree warning unit 130.

The plant information acquisition unit 111 acquires the plant information P11 from the plant information storage unit 101 and outputs the plant information P11 to the plant situation determination unit 121. The plant situation determination unit 121 determines a plant situation P21 on the basis of the plant information P11 and outputs the plant situation P21 to the risk calculation unit 126. The plant information P11 is information directly or indirectly indicating situations of the plant being monitored, such as: data obtained through measurement by various measurement instruments such as a flowmeter, a thermometer, a pressure gauge, or a water gauge; a plant parameter; and alarm information about the plant. In embodiment 1, whether or not an event has occurred in the plant is determined from the plant parameter and the alarm information included in the plant information P11. The event having occurred is identified by using a knowledge base storing therein data necessary for identification of events, such as the relationship between occurrence factors of events and infliction of influences of the events. The plant situation determination unit 121 detects occurrence of an event X in the plant from the plant parameter and the alarm information which have been acquired. That is, determination of the plant situation P21 is performed also for detecting occurrence of an event against which a measure should be taken. The plant situation P21 includes information indicating whether or not the event X has occurred.

The operation information acquisition unit 112 acquires the operation information P12 from the operation information storage unit 102 and outputs the operation information P12 to the operation situation determination unit 122. The operation situation determination unit 122 determines an operation situation P22 on the basis of the operation information P12 and outputs the operation situation P22 to the risk calculation unit 126. The operation information P12 includes an operation manual and information directly or indirectly indicating the present operation situation of the plant being monitored, such as a history of manipulation by the operator. The operation information P12 indicates, for example, a step being currently performed by the operator, whether the step having already been performed has resulted in success or failure, and the like. The operation information P12 is displayed as, for example, an indication of steps. The indication of steps according to embodiment 1 will be described later in detail.

The performance information acquisition unit 113 acquires the performance information P13 from the performance information storage unit 103 and outputs the performance information P13 to the performance situation determination unit 123. The performance situation determination unit 123 determines a performance situation P23 on the basis of the performance information P13 and outputs the performance situation P23 to the operation influencing factor determination unit 125. The performance information P13 is information indicating an internal characteristic of the operator. The performance information P13 includes: static information such as the present proficiency level and experience level and the personality of the operator; and dynamic information such as the psychological state and the physiological state of the operator during a task. The performance information P13 further includes pieces of information such as: a load situation which is an index indicating the degree of physical and cognitive load on the operator; and a degree of arousal which is an index indicating the degree of physical and cognitive attentiveness of the operator. The static information is prestored. The dynamic information is acquired through, for example, measurement by a wearable terminal or input by the operator himself/herself. The performance situation P23 is indicated in, for example, three levels of evaluation or the like. Determination of the performance situation P23 will be described later in detail.

The environment information acquisition unit 114 acquires the environment information P14 from the environment information storage unit 104 and outputs the environment information P14 to the environment situation determination unit 124. The environment situation determination unit 124 determines an environment situation P24 on the basis of the environment information P14 and outputs the environment situation P24 to the operation influencing factor determination unit 125. The environment information P14 is information indicating an external characteristic of the operator. The environment information P14 includes pieces of information such as: the present task environment of the operator, e.g., the air temperature and the humidity, and the brightness of lighting, in the operation room; and an allowance time indicating an allowance time for a step that should be performed. The environment situation P24 indicates the environment in which the operator is present, in three levels of evaluation or the like, for example. Determination of the environment situation P24 will be described later in detail.

The operation influencing factor determination unit 125 determines an operation influencing factor P42 on the basis of the performance situation P23, the environment situation P24, and the operation influencing factor rule P92 respectively acquired from the performance situation determination unit 123, the environment situation determination unit 124, and the operation influencing factor rule storage unit 105. The operation influencing factor determination unit 125 outputs the operation influencing factor P42 to the step importance degree determination unit 128. The operation influencing factor P42 comprehensively indicates the situations on the operator side. The operation influencing factor rule P92 is predetermined and is expressed in, for example, a tabular form as described later. Determination of the operation influencing factor P42 will be described later in detail.

The risk calculation unit 126 calculates a risk P31 on the basis of the plant situation P21, the operation situation P22, and the pieces of risk information P91 respectively acquired from the plant situation determination unit 121, the operation situation determination unit 122, and the risk information storage unit 106. The risk calculation unit 126 outputs the risk P31 to the step importance index calculation unit 127. The risk P31 indicates the probability of failure in the measure against the event against which the measure should be taken. The pieces of risk information P91 are predetermined and are each, for example, a risk tree including an event tree applicable at the time of occurrence of an event X and the probability of failure or success in each of steps, as described later. The risk calculation unit 126 acquires, from the plant situation P21, information about the event against which the measure should be taken, the event being currently underway. Consequently, the risk calculation unit 126 selects, from among the pieces of risk information P91, a corresponding event tree (a risk tree including the event tree regarding the event that is currently underway). In addition, the risk calculation unit 126 acquires, from the operation situation P22, information about the step being performed. Consequently, the risk calculation unit 126 selects, from the risk tree, risk information corresponding to the step being performed such as the probability of failure, for example. Calculation of the risk P31 will be described later in detail.

The step importance index calculation unit 127 calculates step importance indexes P41 on the basis of the risk P31 acquired from the risk calculation unit 126. The step importance index calculation unit 127 outputs the step importance indexes P41 to the step importance degree determination unit 128. Each of the step importance indexes P41 is an index indicating importance of the corresponding step and is calculated on the basis of the risk P31. Calculation of the step importance indexes P41 will be described later.

The step importance degree determination unit 128 determines each of step importance degrees P51 on the basis of the step importance degree rule P93, the corresponding step importance index P41, and the operation influencing factor P42 respectively acquired from the step importance degree rule storage unit 107, the step importance index calculation unit 127, and the operation influencing factor determination unit 125. The step importance degree determination unit 128 outputs the step importance degree P51 to the step information presentation unit 129 and the step importance degree warning unit 130. The step importance degree P51 is obtained by applying the operation influencing factor P42 based on the situations on the operator side to the step importance index P41 based on the situations on the plant side according to the step importance degree rule P93. Similar to each of the step importance indexes P41, each of the step importance degrees P51 indicates importance of the corresponding step. The step importance degree rule P93 is predetermined and is expressed in, for example, a tabular form as described later.

The step information presentation unit 129 presents step information to the operator on the basis of each of the step importance degrees P51 acquired from the step importance degree determination unit 128, the step information being obtained by reflecting the step importance degree P51.

The step importance degree warning unit 130 generates, as necessary, a step importance degree warning (not shown) on the basis of the step importance degree P51 acquired from the step importance degree determination unit 128 and outputs the generated step importance degree warning. The step importance degree warning is outputted to a member of personnel other than the operator who is operating the plant being monitored (a superior or a shift supervisor managing the operator, another operator present nearby, or the like).

Each of the storage units, i.e., the plant information storage unit 101, the operation information storage unit 102, the performance information storage unit 103, the environment information storage unit 104, the risk information storage unit 106, and the operation influencing factor rule storage unit 105, may be included in the plant operation assistance system 100 but may be omitted in a case where the corresponding information can be acquired from outside. Each of the step information presentation unit 129 and the step importance degree warning unit 130 may merely generate the corresponding one of the information to be presented to the operator or the information to be outputted as a warning, and the presentation of the information or the outputting of the warning may be performed by an external output device.

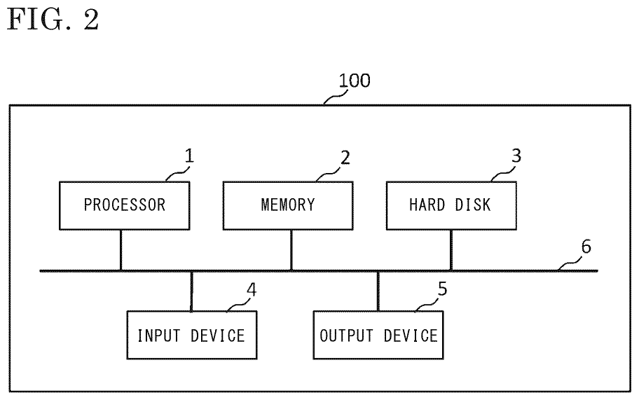

Next, a hardware configuration will be described. FIG. 2 shows an example of a hardware configuration for realizing the functional units of the plant operation assistance system according to embodiment 1.

The plant operation assistance system 100 includes: a processor 1; a storage device including a memory 2 and a hard disk 3; an input device 4 which receives data and a signal from outside; an output device 5 which outputs data and a signal to outside; and a system bus 6 which connects the processor 1, the memory 2, the hard disk 3, the input device 4, and the output device 5. Each of the functional units of the plant operation assistance system 100 shown in FIG. 1 is realized through execution, by the processor 1, of a program stored in the memory 2 or the hard disk 3. A plurality of the processors 1, a plurality of the memories 2, and a plurality of the hard disks 3 may cooperate to realize each of the functional units.

The processor 1 is implemented by, for example, a central processing unit (CPU), an application specific integrated circuit (ASIC), a digital signal processor (DSP), a field programmable gate array (FPGA), or the like. The memory 2 is implemented by a volatile storage device such as a random access memory. The hard disk 3 is an auxiliary storage device and may be substituted with a nonvolatile storage device such as a flash memory. The input device 4 may be, for example, a keyboard, a mouse, a touch panel, etc. The output device 5 is, for example, a displaying device such as a display or a sound output device such as a speaker.

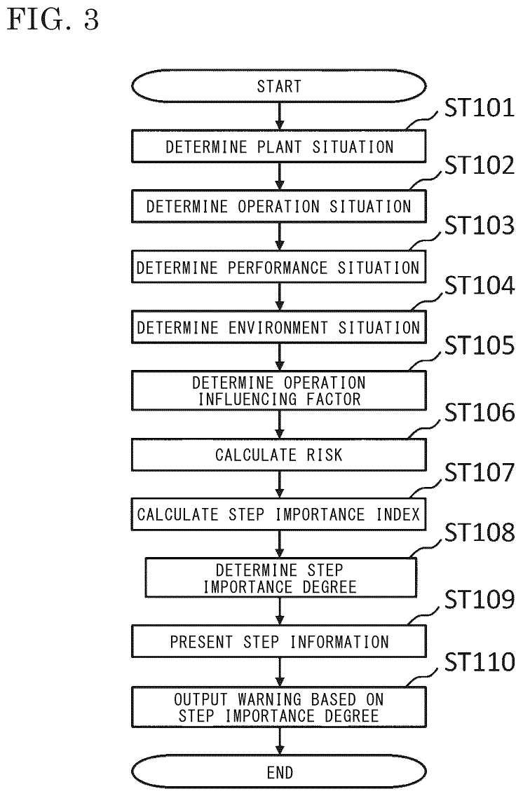

Next, the flow of actions of the plant operation assistance system according to embodiment 1 and details of each of the actions will be described. FIG. 3 is a flowchart showing actions of the plant operation assistance system according to embodiment 1. It is assumed that an event X against which a measure should be taken has occurred while two persons in charge who are an operator A and an operator B are operating a plant being monitored. The operator A is mainly in charge of various manipulations, and the operator A is also in charge of various steps for taking the measure against the event X. The operator B instructs and supervises the operator A and performs the various steps as an assistant to the operator A in a case where, for example, operation of the plant becomes difficult to perform by the operator A alone. In addition, it is assumed that an operator C is also present as a standby person.

Fist, a plant situation P21 is determined (step ST101). The plant information acquisition unit 111 acquires the plant information P11 from the plant information storage unit 101 and outputs the acquired plant information P11 to the plant situation determination unit 121. The plant situation determination unit 121 determines a plant situation P21 from the plant information P11 on the basis of a predetermined criterion. The plant situation determination unit 121 outputs the plant situation P21 to the risk calculation unit 126.

After the plant situation P21 is determined, an operation situation P22 is determined (step ST102). The operation information acquisition unit 112 acquires the operation information P12 from the operation information storage unit 102 and outputs the acquired operation information P12 to the operation situation determination unit 122. The operation situation determination unit 122 determines an operation situation P22 from the operation information P12 on the basis of a predetermined criterion. The operation situation determination unit 122 outputs the operation situation P22 to the risk calculation unit 126.

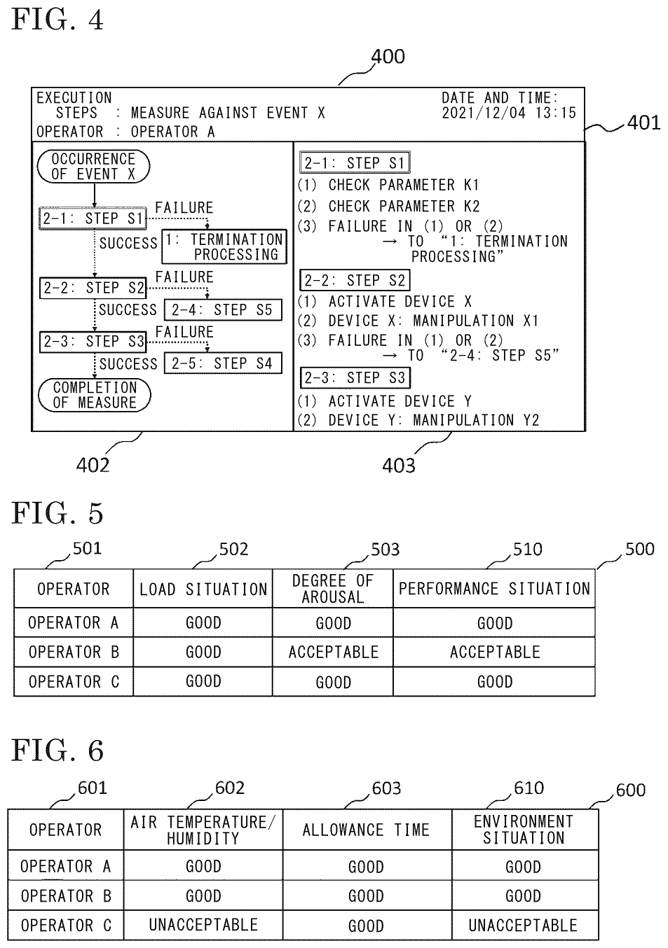

As described above, the operation information P12 is displayed as an indication of steps. FIG. 4 shows an example of the indication of steps according to embodiment 1. The indication of steps 400 includes: a header 401 indicating information such as the date and time, the event against which the measure is being taken, and the operator; a flow-of-steps indication 402; and a details-of-steps indication 403. The flow-of-steps indication 402 sequentially indicates steps (step S1 to step S5) that are subsequent to occurrence of the event X and that include branching portions each based on the result (success or failure) of the corresponding preceding step. The details-of-steps indication 403 indicates specific details of the steps. In the example shown in FIG. 4, the flow-of-steps indication 402 is displayed on the left side of the screen, and the details-of-steps indication 403 is displayed on the right side of the screen. In the indication of steps 400, the step being currently performed is displayed in a style different from the style in which the other steps are displayed, e.g., is displayed in an emphasized style. In the example shown in FIG. 4, only “2-1: STEP S1” is displayed so as to be enclosed by a double line, to indicate that the step being currently performed is step S1. As is seen from the flow-of-steps indication 402, it is indicated that the process proceeds to step S2 in the case of success in step S1, and meanwhile, termination processing is performed in the case of failure in step S1. In embodiment 1, the indication of steps 400 is generated on the basis of the operation manual and the information about the history of manipulation by the operator which are included in the operation information P12. Although the step being currently performed is displayed in a style different from the style in which the other steps are displayed in embodiment 1, the step to be performed next may be displayed in a style different from the style in which the other steps are displayed.

After the operation situation P22 is determined, performance situations P23 are determined (step ST103). The performance information acquisition unit 113 acquires the performance information P13 from the performance information storage unit 103 and outputs the acquired performance information P13 to the performance situation determination unit 123. The performance situation determination unit 123 determines performance situations P23 from the performance information P13 on the basis of a predetermined criterion. The performance situation determination unit 123 outputs the performance situations P23 to the operation influencing factor determination unit 125.

FIG. 5 shows an example of the performance situation determination according to embodiment 1. A performance situation determination table 500 includes: an operator column 501 indicating the operators; a load situation column 502 indicating the present load situations of the respective operators; a degree-of-arousal column 503 indicating the present degrees of arousal of the respective operators; and a performance situation column 510 indicating the present performance situations of the respective operators. In embodiment 1, the performance situations P23 of the respective operators are determined on the basis of the load situations and the degrees of arousal which are included in the performance information P13. As shown in FIG. 5, each of the load information and the degree of arousal is indicated in three levels which are “good”, “acceptable”, and “unacceptable”. The performance situation P23 of each of the operators is determined, as a comprehensive evaluation which is a combination of the corresponding load information and the corresponding degree of arousal, in three levels which are “good”, “acceptable”, and “unacceptable”. In the example in FIG. 5, regarding each of the operator A and the operator C, the load situation and the degree of arousal are “good”, and thus the performance situation P23 is determined to be “good”. Regarding the operator B, the load situation is “good” and the degree of arousal is “acceptable”, and thus the performance situation is determined to be “acceptable”. The performance situation determination table 500 may be stored in the performance situation determination unit 123 or another storage unit (not shown).

After the performance situations P23 are determined, environment situations P24 are determined (step ST104). The environment information acquisition unit 114 acquires the environment information P14 from the environment information storage unit 104 and outputs the acquired environment information P14 to the environment situation determination unit 124. The environment situation determination unit 124 determines environment situations P24 from the environment information P14 on the basis of a predetermined criterion. The environment situation determination unit 124 outputs the environment situations P24 to the operation influencing factor determination unit 125.

FIG. 6 shows an example of the environment situation determination according to embodiment 1. An environment situation determination table 600 includes: an operator column 601 indicating the operators; an air temperature/humidities column 602 indicating the present air temperatures and humidities of operation rooms to which the respective operators have been assigned; an allowance time column 603 indicating the present allowance times for the respective operators; and an environment situation column 610 indicating the present environment situations of the respective operators. In embodiment 1, the environment situations P24 of the respective operators are determined on the basis of the air temperatures and humidities of the operation rooms and the allowance times which are included in the environment information P14. Each of the air temperature/humidities and the allowance time is indicated in three levels which are “good”, “acceptable”, and “unacceptable”. The environment situation P24 of each of the operators is determined, as a comprehensive evaluation which is a combination of the corresponding air temperature/humidities and the corresponding allowance time, in three levels which are “good”, “acceptable”, and “unacceptable”. In the example in FIG. 6, regarding each of the operator A and the operator B, the air temperature/humidities and the allowance time are “good”, and thus the environment situation P24 is determined to be “good”. Regarding the operator C, the air temperature/humidities is “unacceptable” and the allowance time is “good”, and thus the environment situation P24 is determined to be “unacceptable”. The environment situation determination table 600 may be stored in the environment situation determination unit 124 or another storage unit (not shown).

After the environment situations P24 are determined, operation influencing factors P42 are determined (step ST105). The operation influencing factor determination unit 125 determines operation influencing factors P42 from the performance situations P23 and the environment situations P24 on the basis of the operation influencing factor rule P92. The operation influencing factor determination unit 125 outputs the operation influencing factors P42 to the step importance degree determination unit 128.

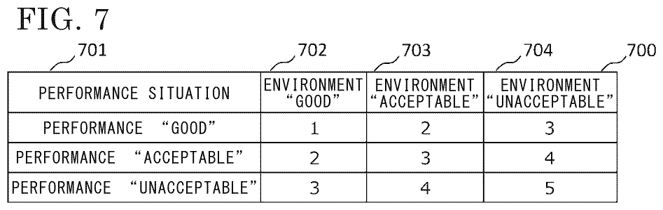

FIG. 7 shows an example of the operation influencing factor rule according to embodiment 1. As shown in FIG. 7, the operation influencing factor rule P92 according to embodiment 1 includes an operation influencing factor rule table 700 in a tabular form. The operation influencing factor rule table 700 includes: a performance situation column 701 indicating performance situations P23; a first environment situation column 702 indicating operation influencing factors P42 in a case where the environment situation P24 is “good”; a second environment situation column 703 indicating operation influencing factors P42 in a case where the environment situation P24 is “acceptable”; and a third environment situation column 704 indicating operation influencing factors P42 in a case where the environment situation P24 is “unacceptable”. The operation influencing factor determination unit 125 determines, from a combination of the performance situation P23 and the environment situation P24 of each of the operators, the corresponding value as an operation influencing factor P42. For example, regarding the operator A, the performance situation P23 is determined to be “good” as shown in FIG. 5, and the environment situation P24 is determined to be “good” as shown in FIG. 6. In this case, “1” which is the value in the first row (corresponding to the performance situation “good”) of the first environment situation column 702 is determined as an operation influencing factor P42 of the operator A. Likewise, regarding the operator B with the performance situation P23 being “acceptable” and with the environment situation P24 being “good”, the operation influencing factor P42 of the operator B is determined to be “2”. Regarding the operator C with the performance situation P23 being “good” and with the environment situation P24 being “unacceptable”, the operation influencing factor P42 of the operator C is determined to be “3”.

After the operation influencing factors P42 are determined, a risk P31 is calculated (step ST106). The risk calculation unit 126 calculates a risk P31 from the plant situation P21 and the operation situation P22 on the basis of the risk information P91. The risk calculation unit 126 outputs the risk P31 to the step importance index calculation unit 127.

The calculation of the risk P31 will be described. In general, in many cases, a “risk” is calculated by using: the product of the probability of occurrence and the magnitude of influence; or a function expressed with the probability of occurrence and the magnitude of influence. However, calculation of the risk P31 according to embodiment 1 is such that, for simplification, the magnitudes of influences of failure in the respective steps for taking the measure against the event X are assumed to be equal to one another, and the probabilities of occurrence, i.e., the probabilities of failure in the respective steps, are directly used as calculation results.

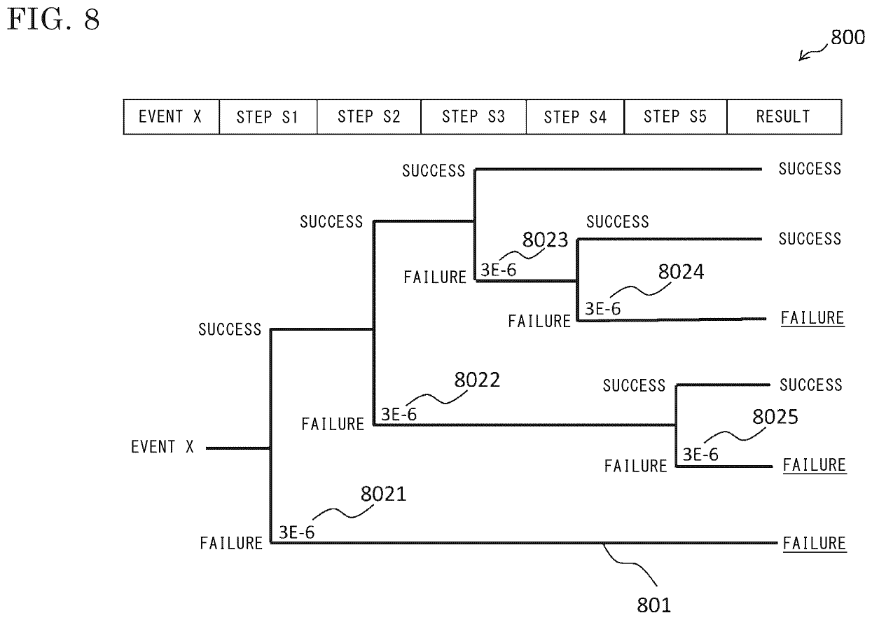

FIG. 8 shows an example of the risk information according to embodiment 1. In a risk tree 800 indicating the risk information P91, occurrence of the event X, execution of steps (step S1 to step S5) for taking the measure against the event X, and final results (whether the measure against the event X has resulted in success or failure) are expressed with an event tree 801. Furthermore, the risk tree 800 shows the probabilities of failure in the respective steps. The probabilities of failure in the respective steps include: a probability of failure 8021 in step S1; a probability of failure 8022 in step S2; a probability of failure 8023 in step S3; a probability of failure 8024 in step S4; and a probability of failure 8025 in step S5. The event tree 801 shows, from the left to the right of the drawing, the occurrence of the event X and the result of execution of each of the steps. The event tree 801 shows that the process proceeds to the upper branch in the case of success in each of the steps, and meanwhile, proceeds to the lower branch in the case of failure in the step. In addition, the final results of the measure against the event X are expressed as “SUCCESS” and “FAILURE”. The lower branch at each branch-off portion of the event tree 801 is denoted by a numerical value which represents the probability of failure 802 in the corresponding step. The probability of failure 802 is expressed in exponential form. Specifically, “E−6” indicates 10 to the negative sixth power. That is, 3E−6=3.0×10⁻⁶ is satisfied. Meanwhile, each of the probability of failure 8021, the probability of failure 8022, the probability of failure 8023, the probability of failure 8024, and the probability of failure 8025 fluctuates owing to influences of the plant situation P21 and the operation situation P22. Considering this, post-fluctuation values are used in the actual calculation of the risk P31. However, for explanations, it is assumed that there are no fluctuations in the probabilities of failure in the respective steps in the following description.

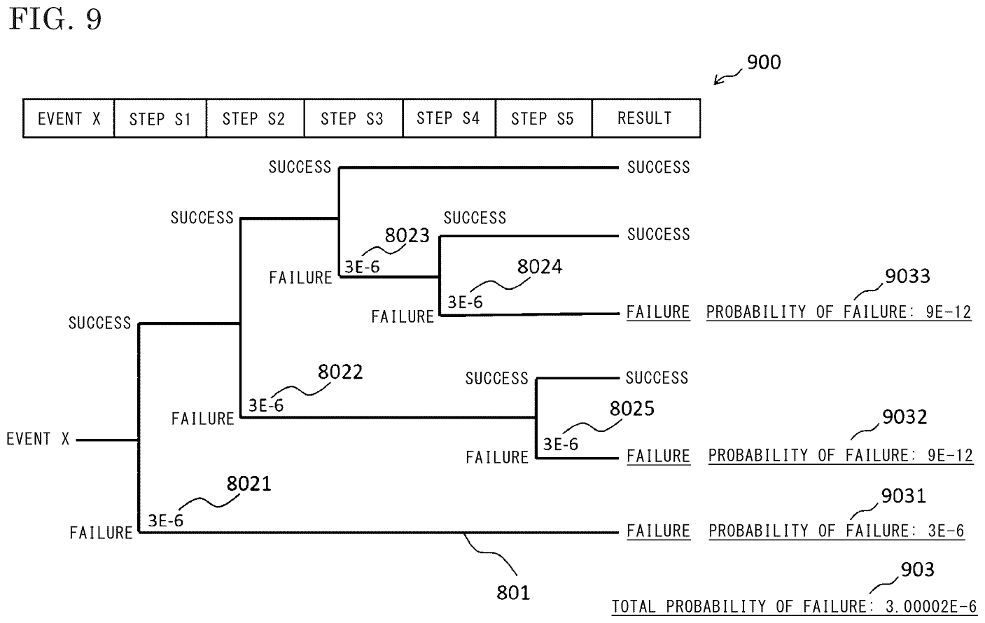

FIG. 9 shows an example of the risk calculation according to embodiment 1. Here, calculation of the risk P31 when the event X occurs will be specifically described with reference to FIG. 9. As described above, the risk P31 is assumed to be equal to a probability of failure in embodiment 1. In a risk tree 900, a calculation result of the risk P31 has been added to the risk tree 800. As cases of failure in the measure against the event X, there are three cases which are: a first case where failure in step S1 occurs; a second case where success in step S1 occurs, failure in step S2 occurs, and then failure in step S5 occurs; and a third case where success in step S1 and success in step S2 occur, failure in step S3 occurs, and then failure in step S4 occurs. Therefore, the probability of occurrence according to the first case is defined as a probability of failure 9031, the probability of occurrence according to the second case is defined as a probability of failure 9032, the probability of occurrence according to the third case is defined as a probability of failure 9033, and the total of the probabilities of occurrence according to the three cases is defined as a total probability of failure 903. Hereinafter, each of the cases will be described. To be exact, the probability of success in each of the steps is 1−(3E−6). However, since the probability of failure is 3E−6 and is sufficiently low, the probability of success approximates to 1.

(First Case: Failure in Step S1)

Since the probability of failure 8021 in step S1 is 3E−6, the probability of failure 9031 according to the first case is 3E−6.

(Second Case: Success in Step S1, Failure in Step

S2, and Failure in Step S5)

Since the probability of success in step S1 is approximately 1, the probability of failure 8022 in step S2 is 3E−6, and the probability of failure 8025 in step S5 is 3E−6, the probability of failure 9032 according to the second case is

$$1 \times 3 E - 6 \times 3 E - 6 = 9 E - 12.$$

(Third Case: Success in Step S1, Success in Step S2, Failure in Step S3, and Failure in Step S4) Since the probability of success in step S1 is approximately 1, the probability of success in step S2 is approximately 1, the probability of failure 8023 in step S3 is 3E−6, and the probability of failure 8024 in step S4 is 3E−6, the probability of failure 9033 according to the third case is

$$1 \times 1 \times 3 E - 6 \times 3 E - 6 = 9 E - 12.$$

(Total Probability of Failure at Time of Occurrence of Event X)

The total probability of failure 903 at the time of occurrence of the event X is the total of the probabilities of failure according to the above three cases, and thus is

$$3 E - 6 + 9 E - 12 + 9 E - 12 = 3.00002 E - 6.$$

The total probability of failure 903 is the calculation result of the risk P31 in embodiment 1.

After the risk P31 is calculated, step importance indexes P41 are calculated (step ST107). The step importance index calculation unit 127 calculates step importance indexes P41 of the respective steps on the basis of the risk P31. The step importance index calculation unit 127 outputs the step importance indexes P41 to the step importance degree determination unit 128.

Each of the step importance indexes P41 in embodiment 1 is an index indicating the degree of relative importance of the corresponding step in the entirety of the procedure. A step having a large step importance index P41 indicates that failure in the step inflicts significant influence on the entirety. In embodiment 1, the following expression (1) is used for obtaining each of the step importance indexes P41. Step importance index=total probability of failure at time of failure in corresponding step/total probability of failure (1)

That is, each of the step importance indexes P41 is calculated through comparison between the total probability of failure calculated without setting any condition and the total probability of failure calculated under a condition that failure in the corresponding step occurs.

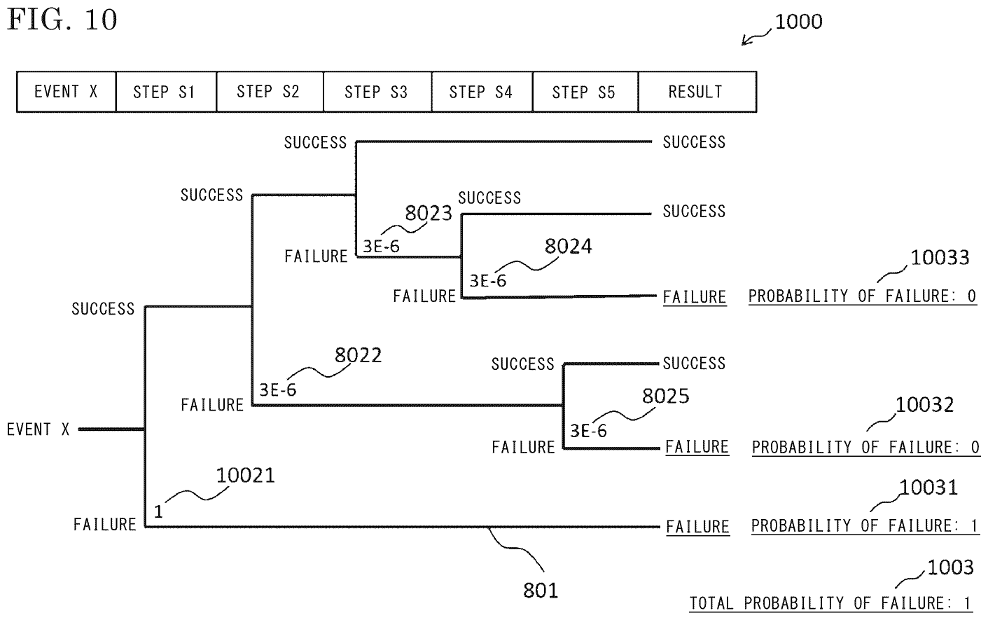

Here, calculation of a step importance index P41 of step S1 will be specifically described by using an example of the risk calculation in FIG. 10. FIG. 10 shows an example of the risk calculation according to embodiment 1.

Specifically, FIG. 10 shows an example of risk calculation performed on the assumption that failure in step S1 inevitably occurs. Therefore, in a risk tree 1000, a probability of failure 10021 in step S1 is 1. In this case as well, the probabilities of occurrence according to the three cases in which failure in the measure against the event X occurs, and the total probability of failure thereof, are calculated.

### First Case: Failure in Step S1

As described above, failure in step S1 is assumed to inevitably occur, and the probability of failure 10021 in step S1 is 1. Therefore, a probability of failure 10031 according to the first case is “1”.

### Second Case: Success in Step S1, Failure in Step S2, and Failure in Step S5

Since failure in step S1 inevitably occurs, the probability of success in step S1 is 0. Therefore, a probability of failure 10032 according to the second case is also “0”.

### Third Case: Success in Step S1, Success in Step S2, Failure in Step S3, and Failure in Step S4

Since failure in step S1 inevitably occurs, the probability of success in step S1 is 0. Therefore, a probability of failure 10033 according to the third case is also “0”.

### Total Probability of Failure at Time of Occurrence of Event X

A total probability of failure 1003 at the time of occurrence of the event X is the total of the probabilities of failure according to the above three cases, and thus is

$$1 + 0 + 0 = 1.$$

### Step Importance Index of Step S1

The total probability of failure at the time of failure in step S1 is the total probability of failure 1003, and the total probability of failure is the total probability of failure 903. Therefore, the step importance index P41 of step S1 is obtained as follows according to expression (1).
Step importance index=1/3.00002E−6=333331

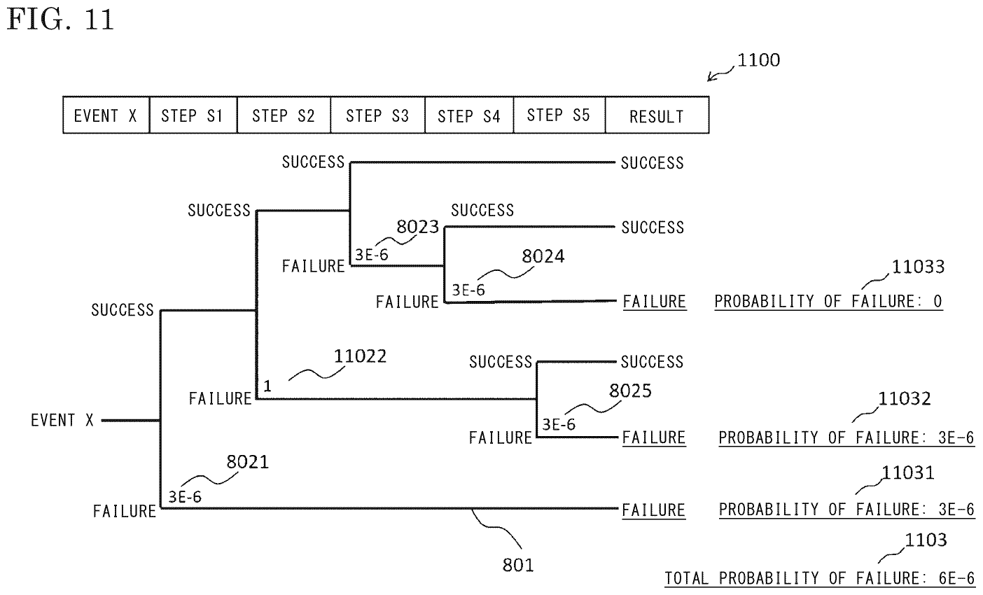

Next, calculation of a step importance index P41 of step S2 will be specifically described by using an example of the risk calculation in FIG. 11. FIG. 11 shows an example of the risk calculation according to embodiment 1.b Specifically, FIG. 11 shows an example of risk calculation performed on the assumption that failure in step S2 inevitably occurs. Therefore, in a risk tree 1100, a probability of failure 11022 in step S2 is 1. In this case as well, the probabilities of occurrence according to the three cases in which failure in the measure against the event X occurs, and the total probability of failure thereof, are calculated.

### First Case: Failure in Step S1

Since the probability of failure 8021 in step S1 is 3E−6, the probability of failure 9031 according to the first case is 3E−6.

### Second Case: Success in Step S1, Failure in Step S2, and Failure in Step S5

Since the probability of success in step S1 is approximately 1, the probability of failure 11022 in step S2 is 1, and the probability of failure 8025 in step S5 is 3E−6, a probability of failure 11032 according to the second case is

$$1 \times 1 \times 3 E - 6 = 3 E - 6.$$

### Third Case: Success in Step S1, Success in Step S2, Failure in Step S3, and Failure in Step S4

Since failure in step S2 inevitably occurs, the probability of success in step S2 is 0. Therefore, a probability of failure 11033 according to the third case is also “0”.

### Total Probability of Failure at Time of Occurrence of Event X

A total probability of failure 1103 at the time of occurrence of the event X is the total of the probabilities of failure according to the above three cases, and thus is

$$3 E - 6 + 3 E - 6 + 0 = 6 E - 6.$$

### Step Importance Index of Step S2

The total probability of failure at the time of failure in step S2 is the total probability of failure 1103, and the total probability of failure is the total probability of failure 903. Therefore, the step importance index P41 of step S2 is obtained as follows according to expression (1).
Step importance index=6E−6/3.00002E−6=1.99999

Step importance indexes P41 of steps S3, S4, and S5 are calculated as follows in the same manner as described above.

### Step Importance Index of Step S3

Step importance index=6.00001E−6/3.00002E−6=1.99999

### Step Importance Index of Step S4

Step importance index=6.00001E−6/3.00002E−6=1.99999

### Step Importance Index of Step S5

Step importance index=6.00001E−6/3.00002E−6=1.99999

After the step importance indexes P41 are calculated, step importance degrees P51 are determined (step ST108). The step importance degree determination unit 128 determines step importance degrees P51 on the basis of the step importance degree rule P93, the step importance indexes P41, and the operation influencing factors P42. The step importance degree determination unit 128 outputs the step importance degrees P51 to the step information presentation unit 129 and the step importance degree warning unit 130.

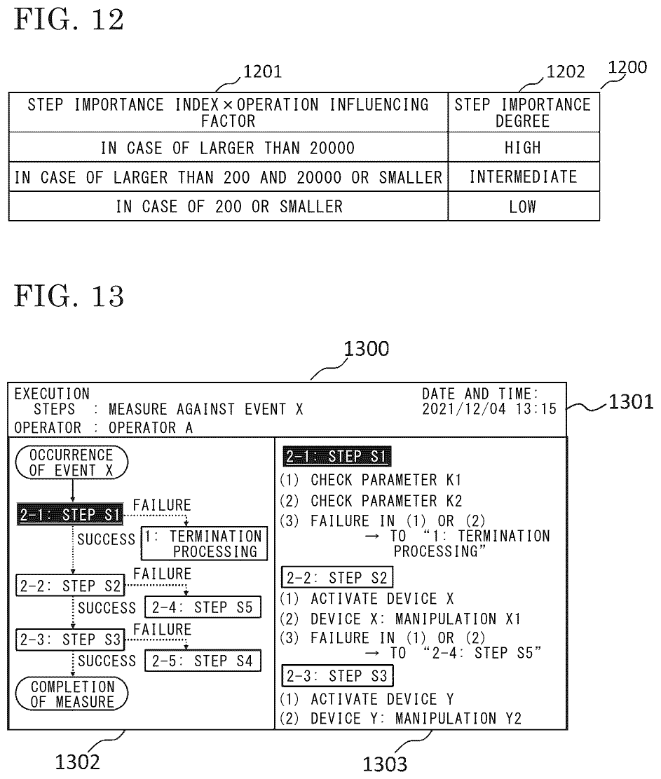

FIG. 12 shows an example of the step importance degree rule according to embodiment 1. As shown in FIG. 12, the step importance degree rule P93 according to embodiment 1 includes a step importance degree rule table 1200 in a tabular form. The step importance degree rule table 1200 includes: a step importance degree determination column 1201 indicating determination conditions for step importance degrees P51; and a step importance degree column 1202 indicating step importance degrees P51. In embodiment 1, each of step importance degrees P51 is determined on the basis of the product of the corresponding step importance index P41 and each of the operation influencing factors P42. Thus, in the step importance degree determination column 1201, ranges of the product of the step importance index P41 and the operation influencing factor P42 are indicated, and, in the step importance degree column 1202, step importance degrees P51 are indicated according to the product of the step importance index P41 and the operation influencing factor P42. As described above, the step importance index P41 of step S1 is 333331, and the operation influencing factor P42 of the operator A who is performing step S1 is 1. Therefore, the product of the step importance index P41 and the operation influencing factor P42 in a case of performing step S1 by the operator A is 333331×1=333331 and is larger than 20000. Thus, the step importance degree P51 in the case of performing step S1 by the operator A is determined to be “high”. Likewise, the product of the step importance index P41 and the operation influencing factor P42 in a case of performing each of steps S2, S3, S4, and S5 by the operator A is 1.99999×1=1.99999 and is in the range of equal to or smaller than 200. Thus, the step importance degree P51 in the case of performing each of steps S2, S3, S4, and S5 by the operator A is determined to be “low”.

After the step importance degrees P51 are determined, pieces of step information in which the step importance degrees P51 have been reflected are presented to the operator (step ST109). The step information presentation unit 129 acquires the step importance degrees P51 from the step importance degree determination unit 128 and presents, to the operator, the pieces of step information in which the step importance degrees P51 have been reflected.

FIG. 13 shows an example of the presentation by the step information presentation unit according to embodiment 1. An indication of steps 1300 presented by the step information presentation unit 129 has the same basic configuration as that of the indication of steps 400 and includes: a header 1301 indicating information such as the date and time, the event against which the measure is being taken, and the operator; a flow-of-steps indication 1302; and a details-of-steps indication 1303. Meanwhile, the step importance degrees P51 have been reflected in the indication of steps 1300 in which each of the steps is displayed in a display style based on the corresponding step importance degree P51 through use of a different color or the like, for example. In the example shown in FIG. 13, step S1 (“2-1: STEP S1”) with the step importance degree P51 being “high” is displayed with white letters on a black background, and each of steps S2, S3, S4, and S5 with the step importance degree P51 being “low” is displayed with black letters.

In addition, a step importance degree warning is outputted on the basis of the step importance degrees P51 (step ST110). The step importance degree warning unit 130 acquires the step importance degrees P51 from the step importance degree determination unit 128. As necessary, the step importance degree warning unit 130 generates a step importance degree warning and outputs the generated step importance degree warning. In embodiment 1, for example, a warning sound is emitted so as to output warnings to a member of personnel other than the operator who is performing operation. Since the step being currently performed (or the step to be performed next) is step S1 and the step importance degree P51 in a case of performing the step by the operator A is “high”, a warning sound is emitted so as to, for example, call for attention of a nearby member of personnel other than the operator, such as a shift supervisor.

The actions shown in FIG. 3 are merely an example, and the present disclosure is not limited thereto. For example, step ST101 and step ST102 may be interchanged in terms of the order thereof so as to determine an operation situation before determining a plant situation, or other ones of the various determinations may be interchanged in terms of the order thereof.

The actions shown in FIG. 3, i.e., step ST101 to step ST110, are performed each time of completion of the corresponding steps, and determination of step importance degrees P51, presentation of pieces of step information, and the like are performed each time of execution of the corresponding steps.

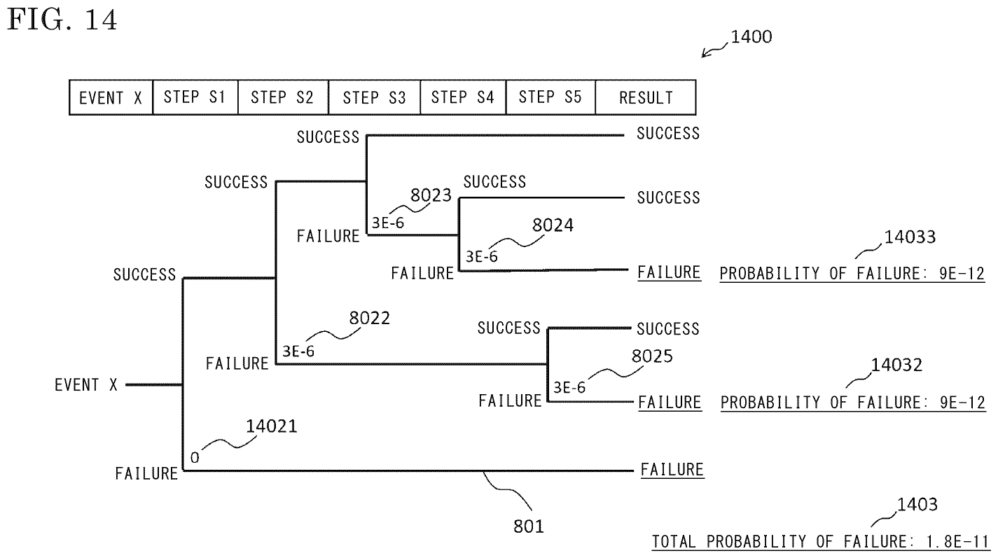

Calculation of a risk P31 and calculation of step importance indexes P41 in a case where the process is assumed to have proceeded to step S2 as a result of success in step S1, will be described. In the case of success in step S1, the operator A performs step S2. Here, the performance situation P23 of the operator A at the time of performing step S2 is assumed to have changed from that at the time of performing step S1. Specifically, the load situation of the operator A is assumed to have deteriorated to “acceptable” from the state shown in FIG. 5, i.e., “good”. The other conditions are assumed to be unchanged. FIG. 14 shows an example of the risk calculation according to embodiment 1. Specifically, FIG. 14 explains risk calculation subsequent to the success in step S1. Since failure in step S1 does not occur, a probability of failure 14021 in step S1 is “0” in a risk tree 1400. In this case as well, the probabilities of occurrence according to the respective cases in which failure in the measure against the event X occurs, and the total probability of failure thereof, are calculated. However, this calculation is risk calculation at the time of performing step S2, and thus only step S2 and the subsequent steps have to be considered. Therefore, as cases of failure in the measure against the event X, there are two cases which are: a fourth case where failure in step S2 occurs, and then failure in step S5 occurs; and a fifth case where success in step S2 occurs, failure in step S3 occurs, and then failure in step S4 occurs.

### Fourth Case: Failure in Step S2 and Failure in Step S5

Since the probability of failure 8022 in step S2 is 3E−6 and the probability of failure 8025 in step S5 is 3E−6, a probability of failure 14032 according to the fourth case is

$$3 E - 6 \times 3 E - 6 = 9 E - 12.$$

### Fifth Case: Success in Step S2, Failure in Step S3, and Failure in Step S4

Since the probability of success in step S2 is approximately 1, the probability of failure 8023 in step S3 is 3E−6, and the probability of failure 8024 in step S4 is 3E−6, a probability of failure 14033 according to the fifth case is

$$1 \times 3 E - 6 \times 3 E - 6 = 9 E - 12.$$

### Total Probability of Failure at Time of Occurrence of Event X

A total probability of failure 1403 at the time of occurrence of the event X is the total of the probabilities of failure according to the above two cases, and thus is

$$9 E - 12 + 9 E - 12 = 1.8 E - 11.$$

Likewise, the total probability of failure at the time of failure in each of the steps and the step importance index P41 of the step are as follows. Detailed calculation thereof is similar to the above calculation, and thus is not described.

### Total Probability of Failure at Time of Failure in Step S2

Since the probability of failure according to the fourth case is 3E−6 and the probability of failure according to the fifth case is “0”, the total probability of failure at the time of failure in step S2 is

$$3 E - 6 + 0 = 3 E - 6.$$

From the total probability of failure at the time of occurrence of the event X described above and the total probability of failure at the time of failure in step S2, the step importance index P41 of step S2 is expressed as follows according to expression (1).

### Step Importance Index of Step S2

Step importance index=3E−6/1.8E−11=166667

### (Total Probability of Failure at Time of Failure in Step S3

Since the probability of failure according to the fourth case is 9E−12 and the probability of failure according to the fifth case is 3E−6, the total probability of failure at the time of failure in step S3 is

$$9 E - 12 + 3 E - 6 = 3 E - 6.$$

From the total probability of failure at the time of occurrence of the event X described above and the total probability of failure at the time of failure in step S3, the step importance index P41 of step S3 is expressed as follows according to expression (1).

### Step Importance Index of Step S3

Step importance index=3E−6/1.8E−11=166667

### Total Probability of Failure at Time of Failure in Step S4

Since the probability of failure according to the fourth case is 9E−12 and the probability of failure according to the fifth case is 3E−6, the total probability of failure at the time of failure in step S4 is

$$9 E - 12 + 3 E - 6 = 3 E - 6.$$

From the total probability of failure at the time of occurrence of the event X described above and the total probability of failure at the time of failure in step S4, the step importance index P41 of step S4 is expressed as follows according to expression (1).

### Step Importance Index of Step S4

Step importance index=3E−6/1.8E−11=166667

Since the probability of failure according to the fourth case is 3E−6 and the probability of failure according to the fifth case is 9E−12, the total probability of failure at the time of failure in step S5 is

$$3 E - 6 + 9 E - 12 = 3 E - 6.$$

From the total probability of failure at the time of occurrence of the event X described above and the total probability of failure at the time of failure in step S5, the step importance index P41 of step S5 is expressed as follows according to expression (1).

### Step Importance Index of Step S5

Step importance index=3E−6/1.8E−11=166667

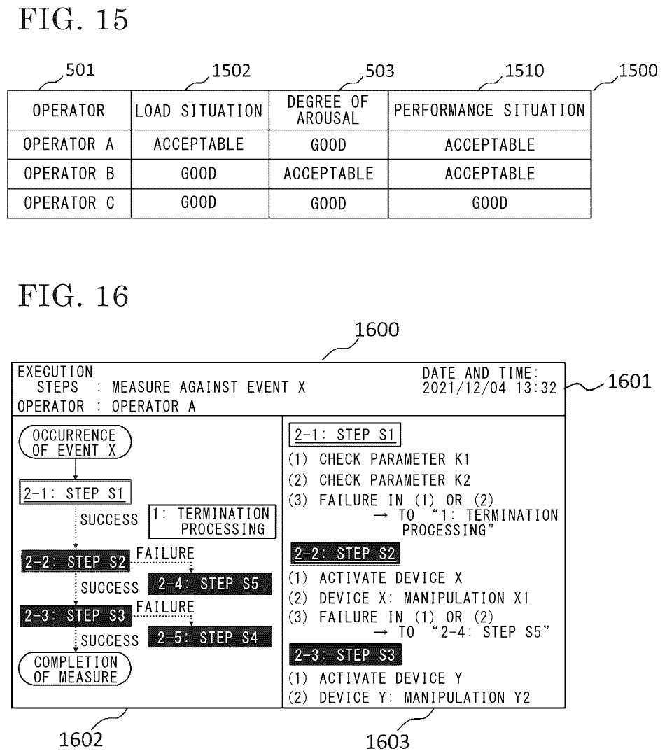

FIG. 15 shows an example of the performance situation determination according to embodiment 1. Specifically, FIG. 15 shows performance situation determination at the time of performing step S2. A performance situation determination table 1500 is basically the same as the performance situation determination table 500 except that, as described above, the load situation of the operator A has deteriorated from “good” to “acceptable” at the time of performing step S2. Therefore, in a load situation column 1502, the load situation of the operator A is “acceptable”. As a result, in a performance situation column 1510, the performance situation P23 of the operator A is determined to be “acceptable”. In this case, the operation influencing factor P42 of the operator A becomes “2” according to the operation influencing factor rule shown in FIG. 7.

As described above, at the time of performing step S2, the step importance index P41 of each of the steps is 166667 and the operation influencing factor P42 of the operator A is “2”, and thus the product of the step importance index P41 and the operation influencing factor P42 is 333334. Therefore, at the time of performing step S2, the step importance degree P51 in the case of performing each of the steps by the operator A is determined to be “high” according to the example of the step importance degree rule shown in FIG. 12.

FIG. 16 shows an example of the presentation by the step information presentation unit according to embodiment 1. Specifically, FIG. 16 shows an example of the presentation at the time of performing step S2. An indication of steps 1600 has the same basic configuration as that of the indication of steps 400 and includes: a header 1601 indicating information such as the date and time, the event against which the measure is being taken, and the operator; a flow-of-steps indication 1602; and a details-of-steps indication 1603. Meanwhile, in the indication of steps 1600, only “2-2: STEP S2” is displayed so as to be enclosed by a double line, to indicate that step S2 is the step being currently performed. Since step S1 has been performed and success in the step has already occurred, step S1 is displayed with black letters, whereas, since the step importance degrees P51 in the case of performing steps S2, S3, S4, and S5 (“2-2: STEP S2” and the like) by the operator A are determined to be “high”, these steps are emphasized by being displayed with white letters on a black background.

Although the plant situation determination unit and the operation situation determination unit respectively determine the present plant situation and the present operation situation in embodiment 1, the plant situation determination unit and the operation situation determination unit can also determine future situations by predicting the future by using a simulator or the like, for example.

Also, although an example in which one plant is

operated has been described for simplification in embodiment 1, the present disclosure is not limited thereto and may be applied to a case where a plurality of plants are simultaneously operated, whereby the degrees of priority of steps for tasks in the plurality of plants can also be determined.

In embodiment 1, change in the situation of the operator can be reflected in determination of degrees of importance of respective steps so that more appropriate operation assistance can be performed. More specifically, embodiment 1 includes: a risk calculation unit which calculates, on the basis of a plant situation including information indicating whether or not an event against which a measure should be taken has occurred, an operation situation including information indicating which of steps is being currently performed, and predetermined risk information, a risk of failure in the measure against the event; a step importance index calculation unit which calculates a step importance index as an index for importance of each of the steps on the basis of the risk; an operation influencing factor determination unit which determines an operation influencing factor of an operator on the basis of a performance situation based on performance information indicating an internal characteristic of the operator, an environment situation based on environment information indicating an external characteristic of the operator, and a predetermined operation influencing factor rule; a step importance degree determination unit which determines, on the basis of the step importance index, the operation influencing factor, and a predetermined step importance degree rule, a step importance degree of the step in a case of performing the step by the operator; and a step information presentation unit which presents, to the operator, step information in which the step importance degree has been reflected.

The risk to be calculated by the risk calculation unit and the step importance index of each of the steps to be calculated on the basis of the risk are calculated on the basis of the plant situation and the operation situation of the plant, i.e., information about the plant. Meanwhile, the operation influencing factor is determined on the basis of the performance situation and the environment information, i.e., information indicating the present state of the operator. Therefore, in the step importance degree determined on the basis of the step importance index and the operation influencing factor, not only the information about the plant but also the present state of the operator has been reflected, whereby change in the situation of the operator has been reflected in determination of the degrees of importance of the respective steps. In addition, step information in which the step importance degree determined as described above has been reflected is presented to the operator, to call for attention of the operator and assist the operator in determining an order of execution of the steps. Consequently, the risk in the plant operation can be mitigated, and the efficiency of tasks can be improved. Therefore, more appropriate operation assistance can be performed.

### Embodiment 2

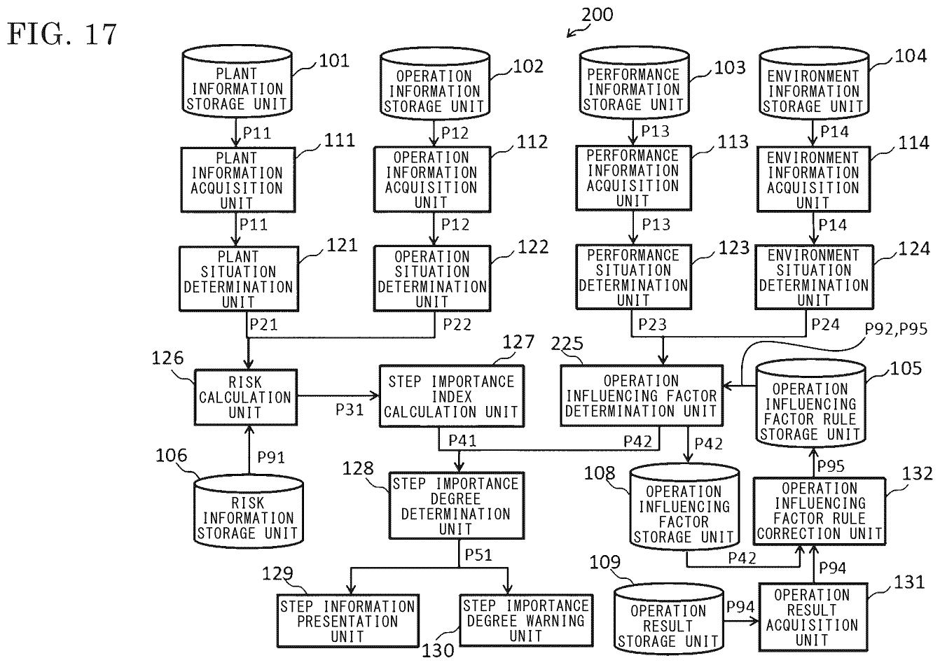

Next, embodiment 2 will be described with reference to FIG. 17 to FIG. 20. It is noted that portions identical or corresponding to those in FIG. 1 to FIG. 16 are denoted by the same reference characters, and description thereof will be omitted. FIG. 17 is a function block diagram showing a plant operation assistance system according to embodiment 2. A plant operation assistance system 200 has the same basic configuration as that of the plant operation assistance system 100 according to embodiment 1, and thus, will be described with focus being placed on differences from the plant operation assistance system 100. FIG. 17 does not show the step importance degree rule storage unit 107 and the step importance degree rule P93 in order to avoid complication of the drawing, and the step importance degree rule storage unit 107 and the step importance degree rule P93 are the same as those in embodiment 1. The hardware configuration for realizing the functional units of the plant operation assistance system 200 is also the same as that in embodiment 1.

The plant operation assistance system 200 further includes an operation influencing factor storage unit 108, an operation result storage unit 109, an operation result acquisition unit 131, and an operation influencing factor rule correction unit 132.

In the same manner as the operation influencing factor determination unit 125 in embodiment 1, an operation influencing factor determination unit 225 determines operation influencing factors P42 of the respective operators and outputs the operation influencing factors P42 to the step importance degree determination unit 128. In addition, the operation influencing factor determination unit 225 stores the operation influencing factors P42 in the operation influencing factor storage unit 108.

The operation result acquisition unit 131 acquires pieces of operation result information P94 indicating operation results regarding the respective operators and stored in the operation result storage unit 109. The pieces of operation result information P94 stored in the operation result storage unit 109 include the speeds of taking measures, the manipulation error rates, and the like of the respective operators. Each of the speeds of taking measures can be obtained by measuring the period from a time at which a step is displayed to a time at which manipulation is performed. Each of the manipulation error rates can be measured through comparison between details of a step and a history of manipulation.

The operation influencing factor rule correction unit 132 creates, as operation influencing factor rules suitable for the respective operators, corrected operation influencing factor rules P95 from the operation influencing factors P42 of the respective operators stored in the operation influencing factor storage unit 108 and the pieces of operation result information P94 about the respective operators acquired by the operation result acquisition unit 131. The operation influencing factor rule correction unit 132 outputs the corrected operation influencing factor rules P95 to the operation influencing factor rule storage unit 105.

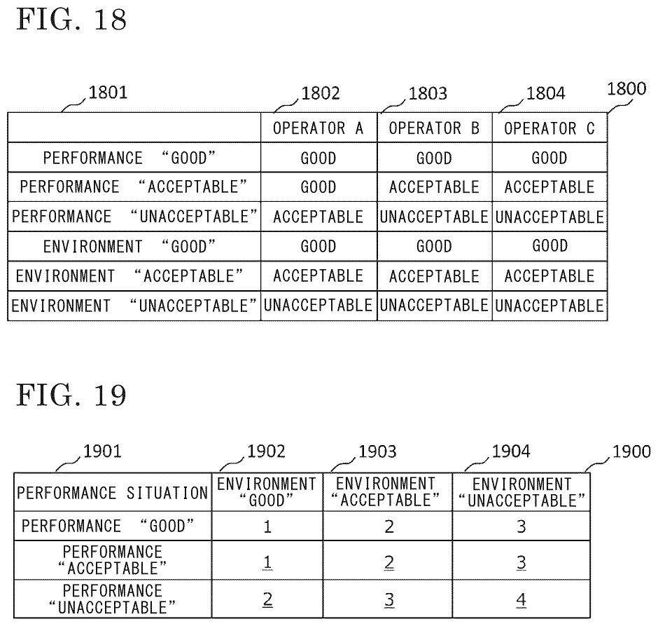

FIG. 18 shows an example of the relationship between the operation influencing factors and the operation results according to embodiment 2. A relationship table 1800 indicates the relationship between elements for determining the operation influencing factors P42, i.e., the performance situations P23 and the environment situations P24, and the operation results regarding the respective operators. The relationship table 1800 includes: an operation influencing factor element column 1801 indicating the elements for determining the operation influencing factors P42; and a first operation result column 1802, a second operation result column 1803, and a third operation result column 1804 respectively indicating operation results regarding the operator A, the operator B, and the operator C correspondingly to each of the elements in the operation influencing factor element column 1801. For example, the first row of the relationship table 1800 indicates the operation results regarding the respective operators obtained when the performance situation P23 is “good”. Comparison between the first row and the third row of the relationship table 1800 makes it possible to ascertain how the operation results regarding the respective operators change between the case where the performance situation P23 is “good” and the case where the performance situation P23 is “unacceptable”. In association with changes in the performance situation P23 in the order of “good”, “acceptable”, and “unacceptable”, the operation results regarding the respective operators change as follows. That is, the operation results regarding the operator B and the operator C change in the order of “good”, “acceptable”, and “unacceptable”, and meanwhile, the operation result regarding the operator A changes in the order of “good”, “good”, and “acceptable”. This relationship indicates that the operation result regarding the operator A is less likely to be influenced by deterioration of the performance situation P23 than the operation results regarding the operator B and the operator C. The relationship table 1800 may be stored in the operation influencing factor rule correction unit 132 or another storage unit (not shown).

The operation influencing factor rule correction unit 132 creates corrected operation influencing factor rules P95 on the basis of the relationship between the elements of the operation influencing factors P42 and the operation results regarding the respective operators which are indicated in the relationship table 1800. FIG. 19 shows an example of the corrected operation influencing factor rule according to embodiment 2. Similar to the operation influencing factor rule table 700, a corrected operation influencing factor rule table 1900 includes: a performance situation column 1901 indicating performance situations P23; a first environment situation column 1902 indicating operation influencing factors P42 in a case where the environment situation P24 is “good”; a second environment situation column 1903 indicating operation influencing factors P42 in a case where the environment situation P24 is “acceptable”; and a third environment situation column 1904 indicating operation influencing factors P42 in a case where the environment situation P24 is “unacceptable”. In the corrected operation influencing factor rule table 1900, values of operation influencing factors P42 different from those in the operation influencing factor rule table 700 shown in FIG. 7 are underlined. As described above, the operation result regarding the operator A is less likely to be influenced by deterioration of the performance situation P23. Therefore, the operation influencing factor P42 in a case where the performance situation P23 is “acceptable” and the operation influencing factor P42 in a case where the performance situation P23 is “unacceptable”, are respectively equal to the operation influencing factor P42 in a case where the performance situation P23 is “good” in the operation influencing factor rule table 700 and the operation influencing factor P42 in a case where the performance situation P23 is “acceptable” in the operation influencing factor rule table 700.

The corrected operation influencing factor rules P95 are also stored in the operation influencing factor rule storage unit 105 and treated in the same manner as the operation influencing factor rule P92. However, the corrected operation influencing factor rules P95 are generated on the basis of the pieces of operation result information P94 about the respective operators and stored correspondingly to the respective operators. When determining an operation influencing factor P42, the operation influencing factor determination unit 225 determines, on the basis of any of the operators for which an operation influencing factor P42 is to be determined, the corresponding corrected operation influencing factor rule P95 or the operation influencing factor rule P92 to be applied. In embodiment 2, the above corrected operation influencing factor rule P95 (corrected operation influencing factor rule table 1900) is used for the operator A, and the operation influencing factor rule P92 (operation influencing factor rule table 700) is used for the operator B and the operator C. In a case where there is no corrected operation influencing factor rule P95 for the corresponding operator, an operation influencing factor P42 is determined by using the operation influencing factor rule P92.

In embodiment 2 as well, the step importance indexes P41 are calculated in the same manner as in embodiment 1. That is, the step importance index P41 of each of the steps at the time of performing step S2 is 166667 as described above. The performance situation P23 of the operator A is determined to be “acceptable”. The environment situation P24 of the operator A is determined to be “good”. As described above, in the case of determining an operation influencing factor P42 of the operator A, the corrected operation influencing factor rule P95 (corrected operation influencing factor rule table 1900) is used. Thus, the operation influencing factor P42 in this case is determined to be “1”. As a result, the product of the step importance index P41 and the operation influencing factor P42 is 166667, and, at the time of performing step S2, the step importance degree P51 in the case of performing each of the steps by the operator A is determined to be “intermediate” from the example of the step importance degree rule shown in FIG. 12.

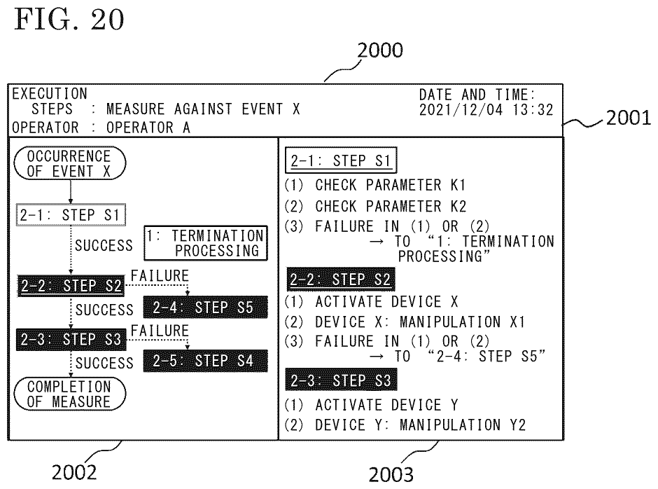

FIG. 20 shows an example of the presentation by the step information presentation unit according to embodiment 2. Specifically, FIG. 20 shows an example of presentation at the time of performing step S2. An indication of steps 2000 has the same basic configuration as that of the indication of steps 1600 and includes: a header 2001 indicating information such as the date and time, the event against which the measure is being taken, and the operator; a flow-of-steps indication 2002; and a details-of-steps indication 2003. Meanwhile, in the indication of steps 2000, the step importance degree P51 in the case of performing each of steps S2, S3, S4, and S5 by the operator A, is determined to be “intermediate”. Therefore, the indication is set to differ from that in the case where the step importance degree P51 is determined to be “high”. For example, the color or the like may be changed. Since the step importance degree P51 is not “high”, no warning is outputted by, for example, emitting a warning sound.

In embodiment 2, the operation result regarding each of the operators is indicated in three levels, and the operation influencing factor rule correction unit 132 has been described as correcting the operation influencing factor rule P92 through a method in which simple means, i.e., comparison between the elements of the operation influencing factors P42 and the operation results, is employed. However, the method for correcting the operation influencing factor rule P92 is not particularly limited, and machine learning including deep learning, or the like, may be employed.

In embodiment 2, the same advantageous effects as those in embodiment 1 can be obtained.

In addition, the accuracies of the step importance degrees can be increased. More specifically, embodiment 2 further includes: an operation result acquisition unit which acquires operation results regarding the respective operators; and an operation influencing factor rule correction unit which compares each of the operation influencing factors and the corresponding operation result and corrects the operation influencing factor rule on the basis of an obtained result of the comparison, to create a corrected operation influencing factor rule. In this configuration, the operation influencing factor rule correction unit creates, for each of the operators, the corresponding corrected operation influencing factor rule, and the operation influencing factor determination unit uses, when determining each of the operation influencing factors, the corrected operation influencing factor rule for the corresponding operator.

For each of the operators, evaluation is performed through comparison of the relationship between the corresponding operation influencing factor and the corresponding operation result, and, on the basis of the result of the evaluation, the operation influencing factor rule is corrected according to the characteristics of the operator. Consequently, the characteristics of the operator can be reflected also in the corresponding step importance degree, and the accuracy of the step importance degree can be increased. As a result, the risk in the plant operation can be further mitigated, and the efficiency of tasks can be further improved.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

100, 200 plant operation assistance system
105 operation influencing factor rule storage unit
106 risk information storage unit
107 step importance degree rule storage unit
108 operation influencing factor storage unit
109 operation result storage unit
111 plant information acquisition unit
112 operation information acquisition unit
113 performance information acquisition unit
114 environment information acquisition unit
121 plant situation determination unit
122 operation situation determination unit
123 performance situation determination unit
124 environment situation determination unit
125, 225 operation influencing factor determination unit
126 risk calculation unit
127 step importance index calculation unit
128 step importance degree determination unit
129 step information presentation unit
130 step importance degree warning unit
131 operation result acquisition unit
132 operation influencing factor rule correction unit
400, 1300, 1600, 2000 indication of steps
500, 1500 performance situation determination table
600 environment situation determination table
700 operation influencing factor rule table
800, 900, 1000, 1100, 1400 risk tree
1200 step importance degree rule table
1900 corrected operation influencing factor rule table
P11 plant information
P12 operation information
P13 performance information
P14 environment information
P21 plant situation
P22 operation situation
P23 performance situation
P24 environment situation
P31 risk
P41 step importance index
P42 operation influencing factor
P51 step importance degree
P91 risk information
P92 operation influencing factor rule
P93 step importance degree rule
P94 operation result information
P95 corrected operation influencing factor rule

1. A plant operation assistance system for assisting an operator in operating a plant, the plant operation assistance system comprising:
a processor for executing a program; and
a memory or a hard disk for storing the program, wherein
acquiring plant information about the plant;
determining, on the basis of the plant information, a plant situation including information indicating whether or not an event against which a measure should be taken has occurred;
acquiring operation information about the plant;
determining, on the basis of the operation information, an operation situation including information indicating which step among one or more steps included in the measure against the event is being currently performed;
acquiring performance information indicating an internal characteristic of the operator;
determining performance situation on the basis of the performance information;
acquiring environment information indicating an external characteristic of the operator;
determining an environment situation on the basis of the environment information;
calculating a risk of failure in the measure against the event on the basis of the plant situation, the operation situation, and predetermined risk information;
calculating a step importance index as an index for importance of each of the steps on the basis of the risk;
determining an operation influencing factor of the operator on the basis of the performance situation, the environment situation, and a predetermined operation influencing factor rule;
determining, on the basis of the step importance index, the operation influencing factor, and a predetermined step importance degree rule, a step importance degree of the step in a case of performing the step by the operator; and
presenting, to the operator, step information in which the step importance degree has been reflected.

2. The plant operation assistance system according to claim 1,
wherein
the following operation is further performed by the program executed by the processor,
acquiring operation results, for the plant, regarding the respective operators;
comparing each of the operation influencing factors and the corresponding operation result; and
correcting the operation influencing factor rule on the basis of an obtained result of the comparison, to create a corrected operation influencing factor rule, wherein
the corrected operation influencing factor rule includes corrected operation influencing factor rules which correspond to each of the operators
the program executed by the processor uses, when determining each of the operation influencing factors, the corrected operation influencing factor rule for the corresponding operator.

3. The plant operation assistance system according to claim 1, wherein
the following operation is further performed by the program executed by the processor
outputting a warning according to the step importance degree.

4. The plant operation assistance system according to claim 3,
wherein
the program executed by the processor outputs the warning to a member of personnel other than the operator who is taking the measure.

5. The plant operation assistance system according to claim 1, wherein the following operation is further performed by the program executed by the processor,
calculating the step importance index of each of the steps through comparison between the risk calculated without setting any condition and the risk calculated under a condition that failure in the step occurs.

6. The plant operation assistance system according to claim 2, wherein the following operation is further performed by the program executed by the processor,
outputting a warning according to the step importance degree.

7. The plant operation assistance system according to claim 6, wherein
the program executed by the processor outputs the warning to a member of personnel other than the operator who is taking the measure.

8. The plant operation assistance system according to claim 2, wherein the following operation is further performed by the program executed by the processor,
calculating the step importance index of each of the steps through comparison between the risk calculated without setting any condition and the risk calculated under a condition that failure in the step occurs.

9. The plant operation assistance system according to claim 3, wherein the following operation is further performed by the program executed by the processor,
calculating the step importance index of each of the steps through comparison between the risk calculated without setting any condition and the risk calculated under a condition that failure in the step occurs.

10. The plant operation assistance system according to claim 4, wherein the following operation is further performed by the program executed by the processor,
calculating the step importance index of each of the steps through comparison between the risk calculated without setting any condition and the risk calculated under a condition that failure in the step occurs.

11. The plant operation assistance system according to claim 6, wherein the following operation is further performed by the program executed by the processor,
calculating the step importance index of each of the steps through comparison between the risk calculated without setting any condition and the risk calculated under a condition that failure in the step occurs.

12. The plant operation assistance system according to claim 7, wherein the following operation is further performed by the program executed by the processor,
calculating the step importance index of each of the steps through comparison between the risk calculated without setting any condition and the risk calculated under a condition that failure in the step occurs.
